(19) United States
(12) Patent Application Publication
(10) Pub. No.: US 2025/0179359 A1
(43) Pub. Date: Jun. 5, 2025

(54) RARE EARTH ALUMINATE PHOSPHOR AND PRODUCTION METHOD THEREOF, WAVELENGTH CONVERSION MEMBER, LIGHT EMITTING DEVICE, AND PROJECTOR

(71) Applicant: NICHIA CORPORATION, Anan-shi (JP)

(72) Inventors: Yasuaki MASHIMA, Tokushima-shi (JP); Sadakazu WAKUI, Tokushima-shi (JP)

(73) Assignee: NICHIA CORPORATION, Anan-shi (JP)

(21) Appl. No.: 18/962,127

(22) Filed: Nov. 27, 2024

(30) Foreign Application Priority Data
Nov. 30, 2023 (JP) 2023-203273

(51) Int. Cl. C09K 11/77; C09K 11/62

(52) U.S. Cl. CPC C09K 11/7774; C09K 11/621; C09K 2211/10

(57) ABSTRACT

A rare earth aluminate phosphor includes: a first element M¹ including at least one selected from the group consisting of yttrium (Y), lanthanum (La), lutetium (Lu), gadolinium (Gd), and terbium (Tb); cerium (Ce); aluminum (Al); oxygen atoms (O) and optionally a second element M² including at least one selected from the group consisting of gallium (Ga) and scandium (Sc). The rare earth aluminate phosphor has a composition in which when a number of moles of oxygen atoms is 12, a total number of moles of the first element M¹ and cerium is 2.9 or more and 3.1 or less, and a total number of moles of aluminum and the second element M² is 4.5 or more and 5.5 or less, and has a reflection spectrum in which a ratio of reflectance at a wavelength of 280 nm to reflectance at a wavelength of 380 nm is 0.33 or more and 0.76 or less.

### CROSS-REFERENCE TO RELATED APPLICATIONS

This application claims priority to Japanese Patent Application No. 2023-203273, filed on Nov. 30, 2023, the disclosure of which is hereby incorporated by reference in its entirety.

### TECHNICAL FIELD

The present disclosure relates to a rare earth aluminate phosphor and a method for producing the same, a wavelength conversion member, a light emitting device, and a projector.

### BACKGROUND

Rare earth aluminate phosphors such as yttrium aluminum garnet phosphors (hereinafter referred to also as a “YAG phosphors”) containing a rare earth such as yttrium and lutetium aluminum garnet phosphors (hereinafter referred to also as a “LuAG phosphors”) containing lutetium are known as phosphors used in light emitting devices for in-vehicle and general lighting, backlights for liquid crystal display devices, light source devices for projectors, and the like, together with light-emitting elements such as light-emitting diodes (hereinafter referred to also as an “LED”) or semiconductor laser diodes (hereinafter referred to also as an “LD”).

Among rare earth aluminate phosphors, Ce-activated rare earth aluminate phosphors emit yellow to green light when excited by irradiation of particle rays such as electron beams, vacuum ultraviolet rays, and blue light, or electromagnetic waves. Ce-activated rare earth aluminate phosphors have a short afterglow, enabling clear images to be obtained. Ce-activated rare earth aluminate phosphors are used in light source devices for projectors, for example, as shown in Japanese Patent Publication No. 2015-138168.

### SUMMARY

One of the objects of an embodiment of the present disclosure is to provide a rare earth aluminate phosphor capable of configuring a wavelength conversion member with high luminescence efficiency, and a manufacturing method thereof.

A first aspect provides a rare earth aluminate phosphor comprising: a first element M¹ including at least one selected from the group consisting of yttrium (Y), lanthanum (La), lutetium (Lu), gadolinium (Gd), and terbium (Tb); cerium (Ce); aluminum (Al); oxygen atoms (O); and optionally a second element M² including at least one selected from the group consisting of gallium (Ga) and scandium (Sc), wherein the rare earth aluminate phosphor has a composition in which when a number of moles of oxygen atoms is 12, a total number of moles of the first element M¹ and cerium is 2.9 or more and 3.1 or less, and a total number of moles of aluminum and the second element M² is 4.5 or more and 5.5 or less, wherein the rare earth aluminate phosphor has a reflection spectrum in which a ratio of reflectance at a wavelength of 280 nm to reflectance at a wavelength of 380 nm is 0.33 or more and 0.76 or less.

A second aspect provides a wavelength conversion member comprising: a substrate; and a wavelength conversion layer disposed on the substrate, the wavelength conversion layer containing a binder and the rare earth aluminate phosphor of the first aspect. A third aspect provides a light emitting device comprising: the wavelength conversion member of the second aspect; and a light source that irradiates the wavelength conversion member with light. A fourth aspect provides a projector comprising: the light emitting device of the third aspect; an image display system; and a projection optical system.

A fifth aspect provides a method for producing a rare earth aluminate phosphor. The production method comprises: providing a first rare earth aluminate comprising: a first element M¹ including at least one selected from a group consisting of yttrium (Y), lanthanum (La), lutetium (Lu), gadolinium (Gd), and terbium (Tb), cerium (Ce), aluminum (Al), oxygen atoms (O); and optionally a second element M² including at least one selected from the group consisting of gallium (Ga) and scandium (Sc), wherein the rare earth aluminate phosphor has a composition in which when a number of moles of oxygen atoms is 12, a total number of moles of the first element M¹ and cerium is 2.9 or more and 3.1 or less, and a total number of moles of aluminum and the second element M² is 4.5 or more and 5.5 or less; and subjecting the first rare earth aluminate to a first heat treatment at a temperature of 900° C. or higher and lower than 1300° C. in a reducing atmosphere to obtain a first heat-treated product.

According to an embodiment of the present disclosure, a rare earth aluminate phosphor capable of configuring a wavelength conversion member with high luminescence efficiency, and a manufacturing method thereof can be provided.

### BRIEF DESCRIPTION OF DRAWINGS

FIG. 1 shows an example of a reflection spectrum of a rare earth aluminate phosphor;

FIG. 2 is a graph showing the relationship between the relative luminescence intensity and the reflectance of a rare earth aluminate phosphor;

FIG. 3 is a diagram showing the relationship between the luminescence efficiency of a wavelength conversion member and the reflectance of a rare earth aluminate phosphor; and

FIG. 4 is a schematic configuration diagram showing an example of the configuration of a light emitting device.

### DETAILED DESCRIPTION

The term “step” as used herein encompasses not only an independent step but also a step not clearly distinguishable from another step as long as the intended purpose of the step is achieved. If multiple substances correspond to a component in a composition, the content of the component in the composition means the total amount of the multiple substances present in the composition unless otherwise specified. Further, upper limit and lower limit values that are described for a numerical range in the present specification can be arbitrarily selected and combined. In this description, a relationship between a color name and a chromaticity coordinate, a relationship between a wavelength range of light and a color name of monochromatic light, etc. comply with JIS Z8110. A half-value width of a phosphor and a light emitting element means a wavelength width (full width at half maximum; FWHM) of the emission spectrum in which the emission intensity is 50% of the maximum emission intensity in the emission spectrum of the phosphor and the light emitting element. In this description, the rare earth aluminate phosphor means an aluminate phosphor having a garnet crystal structure containing a rare earth element, including YAG phosphors and LuAG phosphors. Embodiments of the present disclosure will now be described with reference to the drawings. The embodiments described below are exemplifications of a rare earth aluminate phosphor and a method of producing the same for embodying the technical ideas of the present disclosure, and the present disclosure is not limited to the rare earth aluminate phosphor and the method of producing the same described below.

### Rare Earth Aluminate Phosphor

A rare earth aluminate phosphor may have a composition that includes: a first element M¹ including at least one selected from the group consisting of yttrium (Y), lanthanum (La), lutetium (Lu), gadolinium (Gd), and terbium (Tb); cerium (Ce); aluminum (Al); and oxygen atoms (O) and that optionally includes a second element M² including at least one selected from the group consisting of gallium (Ga) and scandium (Sc). The composition of the rare earth aluminate phosphor may be such that, when the number of moles of oxygen atoms is 12, the total number of moles of the first element M¹ and cerium is 2.9 or more and 3.1 or less and the total number of moles of aluminum and the second element M² is 4.5 or more and 5.5 or less. In the reflection spectrum of the rare earth aluminate phosphor, the ratio of the reflectance at a wavelength of 280 nm to the reflectance at a wavelength of 380 nm may be 0.33 or more and 0.76 or less.

The rare earth aluminate phosphor has a specific composition and has a specific range of reflectance at a wavelength of 280 nm in its reflection spectrum, and therefore can exhibit good luminescence efficiency, for example, when used to form a wavelength conversion member that will be described later. Furthermore, when excited at a short wavelength (e.g., 250 nm or more and 300 nm or less, preferably around 280 nm), the fluorescence lifetime tends to be longer and the luminescence efficiency of the wavelength conversion member tends to be improved. This may be considered to be due to the effect of a change in the valence of Ce, for example.

In the reflection spectrum of the rare earth aluminate phosphor, the ratio (R²⁸⁰/R³⁸⁰) of the reflectance R²⁸⁰ at a wavelength of 280 nm to the reflectance R³⁸⁰ at a wavelength of 380 nm may be preferably 0.36 or more, 0.38 or more, 0.4 or more, 0.45 or more, 0.5 or more, or 0.55 or more, and may be preferably 0.7 or less, 0.66 or less, 0.61 or less, or less than 0.6. When the reflectance ratio is within the above range, the luminescence efficiency of the wavelength conversion member tends to improve at high optical power density. The reflectance of the rare earth aluminate phosphor is calculated from the reflection spectrum of the rare earth aluminate phosphor. It can also be adjusted by a manufacturing method that will be described later.

The reflectance R²⁸⁰ of the rare earth aluminate phosphor at a wavelength of 280 nm may be, for example, 20% or more and 55% or less, preferably 25% or more, 30% or more, or 40% or more, and 54% or less, 52% or less, or 50% or less. The reflectance R³⁸⁰ of the rare earth aluminate phosphor at a wavelength of 380 nm may be, for example, 75% or more and 95% or less, preferably 80% or more or 85% or more, and 92% or less, 90% or less, or 88% or less.

The rare earth aluminate phosphor may have a ratio (T²⁸⁰/T⁴⁴²) of the fluorescence lifetime T²⁸⁰ at an excitation wavelength of 280 nm to the fluorescence lifetime T⁴⁴² at an excitation wavelength of 442 nm, for example, of 1.35 or more, preferably 1.4 or more, more than 1.51, 1.52 or more, 1.53 or more, 1.6 or more, or 1.7 or more. The fluorescence lifetime ratio may be 2.4 or less, or 2 or less. When the fluorescence lifetime ratio is within the above range, the luminescence efficiency of the wavelength conversion member that shows good luminescence efficiency at high optical power density tends to increase. Here, the fluorescence lifetime is measured by exciting the phosphor with a laser pulse having a predetermined wavelength, dispersing the resulting light with a monochromator to measure the number of photons over time, and measuring the time at which the number of photons becomes 1/e of the peak number.

The rare earth aluminate phosphor may have a fluorescence lifetime T²⁸⁰ at an excitation wavelength of 280 nm of, for example, 75 ns or more, preferably 80 ns or more or 85 ns or more, and for example, 110 ns or less. The rare earth aluminate phosphor may have a fluorescence lifetime T⁴⁴² at an excitation wavelength of 442 nm of, for example, 45 ns or more, preferably 50 ns or more or 55 ns or more, and for example, 60 ns or less.

The first element M¹ contained in the composition of the rare earth aluminate phosphor is an element that constitutes a garnet crystal structure together with aluminum, oxygen atoms, and the second element M² contained as necessary. In the composition of the rare earth aluminate phosphor, the first element M¹ may preferably contain at least one selected from the group consisting of Y, Lu, and Tb, and more preferably may contain at least one of Y and Lu. In the composition of the rare earth aluminate phosphor, when the first element M¹ contains Y or Lu, the ratio of the total number of moles of Y and Lu to the total number of moles of the first element M¹ may be, for example, 0.9 or more and 1.0 or less, preferably 0.95 or more, or 0.99 or more.

In the composition of the rare earth aluminate phosphor, when the number of moles of oxygen atoms is 12, the total number of moles of the first element M¹ and cerium may be, for example, 2.9 or more and 3.1 or less, and preferably 2.95 or more and 3.05 or less. The ratio (Ce/(M¹+Ce)) of the number of moles of cerium to the total number of moles of the first element M¹ and cerium may be, for example, 0.002 or more and 0.018 or less, preferably 0.0025 or more, 0.003 or more, or 0.004 or more and 0.015 or less, 0.008 or less, or 0.006 or less.

The composition of the rare earth aluminate phosphor may contain a second element M² as necessary. The second element M2 may contain at least Ga. When the second element M² contains Ga, the ratio of the number of moles of Ga to the whole number of moles of the second element M² may be, for example, 0.9 or more and 1.0 or less, and may be preferably 0.95 or more, or 0.99 or more.

In the composition of the rare earth aluminate phosphor, when the number of moles of oxygen atoms is 12, the total number of moles of aluminum and the second element M² may be, for example, 4.5 or more and 5.5 or less, and preferably 4.75 or more or 5.25 or less. The ratio (M²/(Al+M²)) of the number of moles of the second element M² to the total number of moles of aluminum and the second element M² may be, for example, 0 or more and 0.6 or less, and preferably 0.4 or less, 0.2 or less, 0.1 or less, 0.05 or less, 0.02 or less, or 0.01 or less. The ratio of the number of moles of the second element M² to the total number of moles of aluminum and the second element M² may be, preferably, 0.001 or more, 0.003 or more, or 0.006 or more.

The rare earth aluminate phosphor may have a composition represented by formula (1) below:

(M¹₍₁₋ₚ₎Ceₚ)_{q}(Al₍₁₋ᵣ₎M²ᵣ)ₛO₁₂ (1)

In formula (1), M¹ may contain at least one selected from the group consisting of Y, La, Lu, Gd, and Tb, and preferably contains at least one of Y and Lu. M² may contain at least one selected from Ga and Sc, and preferably contains at least Ga. p, q, r, and s may satisfy 0.002≤p≤0.018, 2.9≤q≤3.1, 0≤r≤0.6, and 4.5≤s≤5.5, and may preferably satisfy 0.003≤p≤0.01, 2.95≤q≤3.05, 0≤r≤0.2, and 4.75≤s≤5.25.

The rare earth aluminate phosphor may have a number average particle size of, for example, 10 μm or more and 60 μm or less, preferably 15 μm or more or 20 μm or more, and 50 μm or less or 40 μm or less. When the number average particle size of the rare earth aluminate phosphor is within the above range, the luminescence intensity tends to improve. The number average particle size of the rare earth aluminate phosphor is measured, for example, by using the Fisher Subsieve Sizer (FSSS) method.

The particle size distribution of the rare earth aluminate phosphor may exhibit, for example, a single-peak particle size distribution, preferably a single-peak particle size distribution with a narrow distribution width, from the viewpoint of improving brightness. Specifically, in the volume-based particle size distribution, assuming that the particle size corresponding to 10% of the cumulative volume from the small diameter side is D₁₀ and that the particle size corresponding to 90% of the cumulative volume from the small diameter side is D₉₀, the ratio (D₉₀/D₁₀) of D₉₀ to D₁₀ may be, for example, 3.0 or less.

The peak luminescence wavelength of the rare earth aluminate phosphor may be, for example, 450 nm or more and 580 nm or less, and preferably 490 nm or more, 500 nm or more, 510 nm or more, or 520 nm or more. The upper limit of the peak luminescence wavelength may be preferably 575 nm or less, 570 nm or less, 560 nm or less, 550 nm or less, 540 nm or less, or 530 nm or less. The half-width value may be, for example, 80 nm or more and 150 nm or less, preferably 90 nm or more, or 95 nm or more, and preferably 140 nm or less, 130 nm or less, 125 nm or less, 110 nm or less, 105 nm or less, or 100 nm or less. The luminescent color of the rare earth aluminate phosphor may have a value of x in the chromaticity coordinates (x, y) in the chromaticity diagram of the CIE 1931 colorimetric system of, for example, 0.29 to 0.35, and preferably 0.299 to 0.338 or less. The value of y may be, for example, 0.52 or more and 0.62 or less, and preferably 0.56 or more or 0.60 or less. The chromaticity coordinates are measured at room temperature (e.g., 25° C.) with an excitation wavelength of 442 nm.

The ratio of the luminescence intensity of a rare earth aluminate phosphor having a reflectance of 40% to the luminescence intensity of a rare earth aluminate phosphor having a reflectance of 20% at a wavelength of 280 nm may be, for example, 1 or more and 1.1 or less, and preferably 1.02 or more, or 1.04 or more.

### Wavelength Conversion Member

The wavelength conversion member includes a substrate and a wavelength conversion layer disposed on the substrate. The wavelength conversion layer includes a binder and a rare earth aluminate phosphor. The wavelength conversion layer including the rare earth aluminate phosphor can configure the wavelength conversion member achieving good luminescence efficiency.

The luminescence efficiency of a light emitting device including a light source, a wavelength conversion member, and an optical system including, for example, a lens and a reflector, is evaluated by the total efficiency, which is the product of the fluorescence efficiency of the wavelength conversion member and the light collection efficiency of the optical system. In other words, the total efficiency of a light emitting device means the luminescence efficiency of the entire light emitting device. The fluorescence efficiency corresponds to the wavelength conversion efficiency of the wavelength conversion member and is evaluated as the ratio of the intensity of light exiting from the wavelength conversion layer to the intensity of light incident from the light source. The light collection efficiency corresponds to the efficiency with which the light exiting from the wavelength conversion member is taken into the optical system, and is evaluated as the ratio of the intensity of light output from the optical system to the intensity of light exiting from the wavelength conversion layer.

A method of evaluating the luminescence efficiency will be described here with reference to the drawings. FIG. 4 is a schematic configuration diagram showing an example of a light emitting device. A light emitting device 200 includes a light source 210, a lens 222 that focuses light from the light source 210 on a wavelength conversion member 250, and a dichroic mirror 224 that reflects output light from the wavelength conversion member 250 and directs the output light toward an emission direction 230. The wavelength conversion member 250 includes a disk-shaped substrate 252 and a wavelength conversion layer 254 including a phosphor and a binder. The wavelength conversion layer 254 is disposed, for example, in an annular shape along the circumference of the substrate 252. The luminescence efficiency of the light emitting device 200 is calculated by dividing the fluorescent output (exiting light intensity) measured by a powermeter at a position B by the excitation output (incident light intensity) measured by a powermeter at a position A. In the evaluation of the fluorescence efficiency, the surface temperature of the wavelength conversion layer 254 may be measured by infrared thermography to confirm that the rise in the surface temperature is suppressed.

The substrate constituting the wavelength conversion member may have a disk shape, a polygonal plate shape, or the like. The thickness of the substrate may be, for example, 0.1 mm or more and 1 mm or less, and preferably 0.4 mm or more or 0.6 mm or less.

The substrate may be a metal member containing a metal material such as aluminum, iron, copper, silver, nickel, stainless steel, etc. The substrate configured as a metal member containing a metal material can reflect the light incident on the wavelength conversion member to the same side as the incident surface through wavelength conversion by the wavelength conversion layer. Furthermore, the heat dissipation from the phosphor is improved, so that the fluorescence efficiency of the wavelength conversion member can be enhanced.

The substrate may be a light-transmitting member containing a light-transmitting material such as glass or aluminum oxide. The substrate configured as a light-transmitting member can allow the light incident on the wavelength conversion member to exit to the opposite side of the incident surface through wavelength conversion by the wavelength conversion layer. At least one of two main surfaces, one on which the wavelength conversion layer of the light-transmitting member is formed, and the other opposite thereto, may be roughened in advance by, for example, etching or laser processing. This may suppress uneven light emission on the light-emitting surface of the wavelength conversion member.

At least a part of the substrate surface may be a reflective surface. The reflective surface may be formed at least in the region where the wavelength conversion layer is disposed. The reflective surface may be formed from a material including at least one selected from the group consisting of silver and aluminum. The reflective surface of the substrate may be formed from the material of the substrate itself. That is, the substrate itself may be formed from a material including at least one selected from the group consisting of silver and aluminum, and at least a part of the surface may be a reflective surface. Alternatively, the reflective surface may be formed by the surface of a reflective layer disposed on the substrate. Examples of materials for forming the reflective layer include silver, aluminum, alloys including at least one selected from silver and aluminum, and resins containing metal oxides such as titanium oxide. The regular reflectance of the reflective surface may be, for example, 80% or more, preferably 85% or more, or 90% or more. The upper limit of the specular reflectance may be, for example, 100% or less. When the specular reflectance of the reflective surface is 80% or more, there is a tendency that the amount of light extracted can be increased. The specular reflectance of the reflective surface of the substrate is measured using light with a wavelength of 450 nm.

The wavelength conversion layer disposed on the substrate may include a binder and a rare earth aluminate phosphor. The binder constituting the wavelength conversion layer may be an organic binder or an inorganic binder. The organic binder may include a cured component of a resin, preferably a cured component of a light-transmitting resin. Examples of the resin include thermosetting resins such as epoxy resin, silicone resin, epoxy-modified silicone resin, and modified silicone resin. The resin including a silicone resin tends to have better heat resistance, light resistance, and the like. The silicone resin or modified silicone resin may include at least one selected from the group consisting of a phenyl silicone resin, a modified phenyl silicone resin, a dialkyl silicone resin, and a modified dialkyl silicone resin. Examples of the inorganic binder include glass, ceramics, and aluminum oxide.

The content of the binder in the wavelength conversion layer may be, for example, 10% by mass or more and 25% by mass or less, preferably 12% by mass or more or 14% by mass or more, and preferably less than 25% by mass, 23% by mass or less, or 20% by mass or less, relative to the total mass of the wavelength conversion layer.

The wavelength conversion layer may further contain other components in addition to the rare earth aluminate phosphor and the binder. Examples of the other components include fillers such as silica, barium titanate, titanium oxide, and aluminum oxide, light stabilizers, and colorants. When the wavelength conversion member contains other components, the content of the other components can appropriately be selected depending on the purpose or the like. For example, when the other components include a filler, the content of the filler can be 0.01 parts by mass or more and 20 parts by mass or less with respect to 100 parts by mass of the binder.

The mass ratio of the rare earth aluminate phosphor to the binder in the wavelength conversion layer may be, for example, 0.5 or more and 7 or less, preferably 0.8 or more or 1.0 or more, and preferably 6 or less.

The average thickness of the wavelength conversion layer may be, for example, 50 μm or more and 200 μm or less, preferably 60 μm or more or 70 μm or more, and preferably 190 μm or less or 180 μm or less. When the average thickness of the wavelength conversion layer is within the above range, the total efficiency of the light emitting device tends to improve. The thickness of the wavelength conversion layer is calculated by subtracting the arithmetic average value of the thickness of the substrate from the arithmetic average value of the total thickness of the wavelength conversion layer and the substrate. The arithmetic average value of the total thickness of the wavelength conversion layer and the substrate and the arithmetic average value of the thickness of the substrate are each calculated from measured values at discretionary six points.

The wavelength conversion layer may have a substantially uniform thickness. The variation coefficient of the thickness of the wavelength conversion layer may be, for example, 0.4 or less, preferably 0.3 or less. The lower limit of the variation coefficient of the thickness of the wavelength conversion layer may be, for example, 0.09 or more. The variation coefficient of the thickness of the wavelength conversion layer is calculated by dividing the standard deviation of the thickness of the wavelength conversion layer by the average thickness of the wavelength conversion layer.

In an embodiment, the wavelength converting member may include the disk-shaped substrate having a reflective surface, and the wavelength converting layer disposed on the reflective surface of the substrate in an annular shape along the circumference of the substrate.

### Light Emitting Device

The light emitting device includes a wavelength conversion member and a light source that irradiates the wavelength conversion member with light. The light emitting device is configured to emit a mixed color light of light from the light source and light from the wavelength conversion member irradiated with the light from the light source. By including a wavelength conversion member having a specific configuration, the light emitting device can achieve good total efficiency. Details of the wavelength conversion member constituting the light emitting device are as described above.

In an embodiment, the light emitting device may further include a motor that rotates the wavelength conversion member. The wavelength conversion member may be fixed to a rotation shaft of the motor and arranged to be rotatable by the motor.

Examples of the light source irradiating the wavelength conversion member with light include a light emitting element. The light emitting element may be a semiconductor light emitting element, a light emitting diode, or a laser diode. The light emitting element(s) constituting the light source may be of one type alone or a combination of two or more types. Furthermore, there may be one or more light emitting elements constituting the light source.

The light source may have a luminescence peak wavelength within a wavelength range of, for example, 400 nm or more and 500 nm or less. The luminescence peak wavelength of the light source may preferably be within a wavelength range of, for example, 420 nm or more and 480 nm or less. The half-value width of the light source may be, for example, 30 nm or less.

The output of the light source may have an optical power density irradiated onto the wavelength conversion member of, for example, 50 mW/mm² or more and 1000 mW/mm² or less, and preferably 300 W/mm² or more, or 600 W/mm² or more, and 800 W/mm² or less, or 700 W/mm² or less.

The light emitting device can constitute, for example, a projector that will be described later. By using a light emitting device that exhibits good total efficiency, a high-output projector can be configured. The light emitting device can be used not only as a light source device for a projector, but also as a light emitting device included in a light source of: for example, a general lighting device such as a ceiling light; a special lighting device such as a spotlight, stadium lighting, or studio lighting; a vehicle lighting device such as a headlamp; a projection device such as a head-up display; an endoscope light; an imaging device for a digital camera, a mobile phone, a smartphone, and the like; a liquid crystal display device for a monitor for a personal computer (PC), and a laptop personal computer, a television, a personal digital assistant (PDA), a smartphone, a tablet PC, a mobile phone, etc.

### Projector

The projector includes the light emitting device described above, an image display system, and a projection optical system. In the projector, a mixture of light from a light source and light obtained by wavelength conversion of the light from the light source by using a wavelength conversion member is irradiated onto the image display system. The image display system converts the irradiated light into an image and projects it outside via the projection optical system.

The details of the light source and wavelength conversion member constituting the projector are as described above. The image display system displays an image projected by the projector. The image display system may be a liquid crystal panel, a digital mirror device (DMD), or the like. The projection optical system projects to the outside an image obtained by converting light emitted from the wavelength conversion member by the image display system. The configuration of the projection optical system includes a plurality of lenses and is capable of adjusting zoom, focus, etc. In addition to the above configuration, the projector includes lenses, dichroic mirrors, and the like. The projector may further include mirrors, dichroic mirrors, lenses, prisms, and the like, depending on the design of the projector.

### Method for Producing Rare Earth Aluminate Phosphor

A method for producing a rare earth aluminate phosphor includes: a provision step of providing a first rare earth aluminate having a composition that includes: a first element M¹ including at least one selected from the group consisting of yttrium (Y), lanthanum (La), lutetium (Lu), gadolinium (Gd), and terbium (Tb); cerium (Ce); aluminum (Al); and oxygen atoms (O) and that optionally includes a second element M² including at least one selected from the group consisting of gallium (Ga) and scandium (Sc), in which, when the number of moles of oxygen atoms is 12, the total number of moles of the first element M¹ and cerium is 2.9 or more and 3.1 or less and the total number of moles of the aluminum and the second element M² is 4.5 or more and 5.5 or less; and a first heat treatment step of subjecting the first rare earth aluminate to a first heat treatment at a temperature of 900° C. or higher and lower than 1300° C. in a reducing atmosphere to obtain a first heat-treated product containing a second rare earth aluminate. The second rare earth aluminate may be the desired rare earth aluminate phosphor.

The second rare earth aluminate phosphor contained in the first heat-treated product obtained by heat-treating the first rare earth aluminate at a specific heat-treating temperature under a reducing atmosphere can achieve good luminescence efficiency when forming a wavelength conversion member. This can be considered as follows, for example. By heat treatment in a suitable reducing atmosphere, not only trivalent cerium (Ce³⁺) contributing to luminescence, but also tetravalent cerium (Ce⁴⁺) not directly contributing to luminescence is generated in some amount. Under high-density excitation, some of excited electrons are dissipated as heat, but due to the presence of Ce⁴⁺, some of the electrons are recombined and Ce⁴⁺ changes to Ce³⁺, contributing to luminescence. In other words, the luminescence efficiency is thought to improve by the combination of some of the dissipated electrons by Ce⁴⁺.

In the provision step, a first rare earth aluminate having a specific composition is provided. The first rare earth aluminate may be provided by handover or by a conventional method to produce a first rare earth aluminate having a desired composition. The method for producing the first rare earth aluminate will be described later.

In the first heat treatment step, the provided first rare earth aluminate is subjected to the first heat treatment in a reducing atmosphere at a temperature of 900° C. or more and less than 1300° C. to obtain a first heat-treated product. Examples of the first heat treatment in a reducing atmosphere include heat treatment in the presence of a carbon source and heat treatment in an atmosphere containing a reducing gas. The first heat treatment may be a heat treatment in an atmosphere with a lowered oxygen concentration, for example, a heat treatment under lowered pressure. The heat treatment in the presence of a carbon source may be performed, for example, by using a sealed container containing the first rare earth aluminate and the carbon source and heat-treating the sealed container. In this case, the first rare earth aluminate may be contained in an open container separately from the carbon source or may be contained in the same container together with the carbon source. The heat treatment in the presence of a carbon source may be performed by placing a first container containing the first rare earth aluminate on the carbon source and heat-treating the sealed container formed by covering the first container and the carbon source with a second container. By carrying out the heat treatment together with a carbon source, the heat treatment can be performed in a reducing atmosphere.

Examples of the carbon source forming the reducing atmosphere include: carbonaceous materials such as activated carbon, carbon black, and carbon nanotubes; hydrocarbon compounds; and polymers such as polyolefin, polyvinyl alcohol, phenolic resin, and polyamide resin. The reducing atmosphere in the first heat treatment may contain an inert gas. Examples of the inert gas include nitrogen gas and rare gases such as argon. The first heat treatment may also be performed by heat treating a sealed container containing the first rare earth aluminate and the carbon source in a normal atmosphere. The amount of the carbon source used may be, for example, 1% by mass or more and 70% by mass or less, preferably 3% by mass or more or 50% by mass or less, of the mass of the first rare earth aluminate.

The atmosphere containing a reducing gas may be a mixed atmosphere of a reducing gas and an inert gas. Examples of the reducing gas include hydrogen gas, ammonia gas, carbon monoxide gas, and hydrocarbon gas. Examples of the inert gas include nitrogen gas and rare gases such as argon. When the atmosphere for heat treatment contains a reducing gas and an inert gas, the content percentage of the reducing gas in the mixed atmosphere may be, for example, 1% by volume or more and 10% by volume or less, and preferably 3% by volume or more and 4% by volume or less.

The heat treatment temperature in the first heat treatment step may be, for example, 900° C. or more and less than 1300° C., preferably 950° C. or more, 1000° C. or more, or 1050° C. or more, and 1250° C. or less, 1200° C. or less, or 1150° C. or less. When the temperature of the first heat treatment is within the above range, the wheel efficiency tends to rise. The duration of the first heat treatment may be, for example, 2 hours or more and 30 hours or less, preferably 4 hours or more or 26 hours or less. The duration of the heat treatment means the time from reaching a predetermined temperature until the temperature starts to fall, and the same applies hereinafter. The first heat treatment step may be performed using, for example, a tubular furnace, a high-frequency furnace, a metal furnace, an atmosphere furnace, a gas pressure furnace, or the like.

The method for producing a rare earth aluminate phosphor may further include, prior to the first heat treatment step, a second heat treatment step of subjecting the first rare earth aluminate to a second heat treatment in the presence of oxygen. The second heat treatment may further improve the wheel efficiency.

The atmosphere of the second heat treatment may contain oxygen gas and an inert gas. The oxygen content in the atmosphere of the second heat treatment may be, for example, 10% by volume or more and 30% by volume or less, and preferably 15% by volume or more or 25% by volume or less. The second heat treatment step may be performed, for example, in the normal atmosphere.

The temperature of the second heat treatment may be, for example, 900° C. or more and 1400° C. or less, and preferably 1000° C. or more or 1350° C. or less. The temperature of the second heat treatment may be higher than the temperature of the first heat treatment. The difference between the temperature of the second heat treatment and the temperature of the first heat treatment may be, for example, 10° C. or more and 400° C. or less, and preferably 100° C. more or 300° C. or less. The duration of the second heat treatment may be, for example, 2 hours or more and 10 hours or less, and preferably 4 hours or more or 8 hours or less.

When the method for producing a rare earth aluminate phosphor includes the second heat treatment step, the first heat treatment step may be performed continuously by lowering the temperature to a predetermined temperature posterior to the second heat treatment step. Alternatively, the first heat treatment step may be performed in two stages by lowering the temperature to around room temperature after the second heat treatment step and then raising the temperature to a predetermined temperature.

The method for producing a rare earth aluminate phosphor may further include a dispersion step of wet-dispersing the first heat-treated product to obtain a dispersion-treated product. By carrying out the dispersion treatment, the particle size of the obtained rare earth aluminate phosphor tends to become more uniform. The wet dispersion of the first heat-treated product can be carried out, for example, by dispersing a mixture containing the first heat-treated product and a liquid medium using a bead mill, a jet mill, a ball mill, a disk mill, or the like. Examples of the liquid medium used in the dispersion treatment include water, alcohol-based solvents, ether-based solvents, ketone-based solvents such as acetone, and hydrocarbon-based solvents such as toluene. The content of the liquid medium in the mixture may be, for example, 10% by mass or more and 400% by mass or less, preferably 50% by mass or more or 200% by mass or less, of the mass of the first heat-treated product.

When a bead mill is used for wet dispersion, examples of the material of the beads used include alumina, zirconia, etc. The particle size of the beads may be, for example, 1 mm or more and 10 mm or less. The temperature in the wet dispersion may be, for example, 5° C. or more and 40° C. or less. The duration of the dispersion treatment may be, for example, 2 hours or more and 50 hours or less.

The method for producing a rare earth aluminate phosphor may include solid-liquid separation, drying, classification, etc., subsequent to the dispersion step. The solid-liquid separation of the dispersed product may be carried out, for example, by a method commonly used in industry, such as filtration, suction filtration, pressure filtration, centrifugation, decantation, etc. The solid matter recovered by solid-liquid separation may be dried using a device commonly used in industry, such as a vacuum dryer, a hot air heating dryer, a conical dryer, a rotary evaporator, etc. The drying temperature may be, for example, 50° C. or higher and 200° C. or lower, and preferably 80° C. or higher and 130° C. or lower. The drying duration may be, for example, 0.5 hours or more and 200 hours or less, and preferably 1 hour or more and 20 hours or less.

The method for producing a rare earth aluminate phosphor may further include an acid treatment step of bringing an acidic liquid medium containing an acid component into contact with the first heat-treated product to obtain an acid-treated product. The first heat-treated product to be subjected to the acid treatment step may be the first heat-treated product after the wet dispersion treatment, or may be the first heat-treated product before the wet dispersion treatment. The acidic liquid medium used in the acid treatment step may contain, for example, a liquid medium containing water, and an acid component. Examples of the acid component include: inorganic acids such as hydrochloric acid, nitric acid, sulfuric acid, phosphoric acid, and hydrofluoric acid; and organic acids such as formic acid and acetic acid. The acid component contained in the liquid medium may be of one type alone, or may be of a combination of two or more types. The acidic liquid medium may contain at least water, and may contain a water-soluble organic solvent such as alcohol in addition to water as necessary. The content of the acid component in the acidic liquid medium may be, for example, 0.1% by mass or more and 40% by mass or less, and preferably 5% by mass or more and 10% by mass or less. The acidic liquid medium may have a pH of, for example, 1.0 or more and 3.0 or less, preferably 1.2 or more and 2.5 or less. The amount of the acidic liquid medium for use in contact with the first heat-treated product may be, for example, 1% by mass or more and 30% by mass or less, preferably 5% by mass or more and 20% by mass or less, of the mass of the first heat-treated product.

The contact between the first heat-treated product and the acidic liquid medium can be carried out by mixing the first heat-treated product and the acidic liquid medium in a suitable container. At this time, the mixture may be stirred if necessary. The temperature of contact between the first heat-treated product and the acidic liquid medium may be, for example, 5° C. or higher and 40° C. or lower. The contact duration may be, for example, 0.1 hours or more and 10 hours or less.

The method for producing a rare earth aluminate phosphor may include solid-liquid separation, washing, drying, classification, etc., after the acid treatment step.

The method for producing a rare earth aluminate phosphor may further include a synthesis step of producing a first rare earth aluminate. The synthesis step may include, for example, providing a raw material mixture and heat-treating the raw material mixture. By heat-treating the raw material mixture having a desired composition, a first rare earth aluminate having a desired composition can be synthesized.

The raw material mixture may include: a first element M¹ source including at least one selected from the group consisting of yttrium, lanthanum, lutetium, gadolinium, and terbium; a cerium source; an aluminum source; and may further include a second element M² source including at least one selected from the group consisting of gallium and scandium, as necessary.

The first element M¹ source, cerium source, aluminum source, and second element M² source constituting the raw material mixture may be metal compounds, simple substances, alloys, etc. containing the respective metal elements. Examples of the metal compounds include oxides and metal salts. Examples of the metal salts include oxalates, carbonates, halides, nitrates, sulfates, etc. The metal compounds used as raw materials may be in the form of hydrates.

Specific examples of the source of the first element M¹ include: oxides such as Y₂O₃, La₂O₃, Lu₂O₃, Gd₂O₃, and Tb₄O₇; and metal salts such as YCl₃, Y₂(C₂O₄)₃, Y₂(CO₃)₃, Y(NO₃)₃, Y₂(SO₄)₃, LaCl₃, La₂(C₂O₄)₃, La₂(CO₃)₃, La(NO₃)₃, La₂(SO₄)₃, LuCl₃, Lu₂(C₂O₄)₃, Lu(NO₃)₃, Lu₂(SO₄)₃, GdCl₃, and TbCl₃. Specific examples of the cerium source include: oxides such as CeO₂; and metal salts such as CeCl₃ and Ce₂(SO₄)₃. Specific examples of the aluminum source include: oxides such as Al₂O₃; and metal salts such as AlCl₃, Al(NO₃)₃ and Al₂(SO₄)₃. Specific examples of the source of the second element M² include: oxides such as Ga₂O₃ and Sc₂O₃; and metal salts such as GaCl₃, Ga(N O₃)₃, ScCl₃, and Sc(N O₃)₃.

The raw material mixture may have a composition in which the total number of moles of aluminum and the second element M² is 4.5 or more and 5.5 or less, and preferably 4.75 or more or 5.25 or less, for example, when the total number of moles of the first element M¹ and cerium is 3. The raw material mixture may have a composition in which the ratio of the number of moles of cerium to the total number of moles of the first element M¹ and cerium is 0.002 or more and 0.018 or less, and preferably 0.003 or more or 0.004 or more, and preferably 0.015 or less, 0.008 or less, or 0.006 or less. The raw material mixture may have a composition in which the ratio of the number of moles of the second element M² to the total number of moles of aluminum and the second element M² is 0 or more and 0.6 or less, preferably 0.001 or more, 0.003 or more, or 0.006 or more, and preferably 0.2 or less, 0.1 or less, 0.05 or less, 0.02 or less, or 0.01 or less.

The raw material mixture may further contain a specific compound including at least one element selected from the group consisting of barium (Ba), strontium (Sr), calcium (Ca), magnesium (Mg) and manganese (Mn). The specific compound may be a compound that functions as a flux in the synthesis step. When the raw material mixture contains a flux, the reactions between the raw materials may be promoted, with the result that the solid-phase reaction may proceed more uniformly. This is thought to be because the temperature at which the raw material mixture is heat-treated is substantially the same as or higher than the liquid phase generation temperature of the compound used as the flux, thus promoting the solid-phase reaction.

The specific compound may be, for example, a halide, preferably at least one of fluoride and chloride, more preferably fluoride. The specific compound may be, for example, barium fluoride. It is believed that the use of barium fluoride makes the garnet crystal structure of the rare earth aluminate more stable and facilitates the formation of a garnet crystal structure composition. The content of the specific compound in the raw material mixture may be, for example, 0.5% by mass or more and 10% by mass or less, preferably 1.0% by mass or more and 8.0% by mass or less, or 1.5% by mass or more and 7.0% by mass or less. When the content of the specific compound is within the above range, the reactions between the raw materials are further promoted, allowing the solid-phase reaction to proceed more uniformly, whereupon the first rare earth aluminate having the intended composition tends to be easily obtained.

The raw material mixture can be obtained by weighing each raw material so as to achieve a desired composition and then mixing them. The mixing method may be, for example: grinding and mixing using a dry grinder such as a ball mill, a vibration mill, a hammer mill, a roll mill, or a jet mill; grinding and mixing using a mortar and a pestle; mixing using a mixer such as a ribbon blender, a Henschel mixer, or a V-type blender; or grinding and mixing using both a dry grinder and a mixer. The mixing may be dry mixing or may be wet mixing in which a solvent or the like is added. The mixing may preferably be dry mixing. Dry mixing tends to shorten the process time compared to wet mixing, leading to improved productivity.

The heat treatment of the raw material mixture may be carried out by placing the raw material mixture in a container such as a crucible or a boat. Examples of the material for the container include: carbon materials such as graphite; boron nitride (BN); aluminum oxide (alumina); tungsten (W); and molybdenum (Mo).

The temperature of the heat treatment of the raw material mixture may be, for example, 1400° C. or more and 1800° C. or less, preferably 1450° C. or more, 1500° C. or more, or 1600° C. or more, and preferably 1700° C. or less, or 1650° C. or less. When the heat treatment temperature is within the above range, the crystal structure of the first rare earth aluminate tends to have a further improved stability. The heat treatment duration may be, for example, 1 hour or more and 20 hours or less, preferably 3 hours or more, 5 hours or more, or 8 hours or more, and preferably 15 hours or less, or 12 hours or less. The heat treatment may be carried out using, for example, an electric furnace, a gas furnace, or the like.

The atmosphere for the heat treatment may be, for example, a reducing atmosphere. The reducing atmosphere has been described above. In a reducing atmosphere, the reactivity of the raw material mixture improves and a desired first rare earth aluminate can be obtained by heat treatment at normal atmospheric pressure without pressurization. Also, by heat treating the raw material mixture in a reducing atmosphere, tetravalent Ce(Ce⁴⁺) is reduced to trivalent Ce(Ce³⁺), so that a first rare earth aluminate with increased proportion of trivalent Ce contributing to luminescence tends to be obtained.

The synthesis step may include crushing/grinding, washing, drying, classifying, etc., as necessary after the heat treatment.

### EXAMPLES

The present disclosure will now be described in more detail with reference to examples, but the present disclosure is not limited to these examples.

### Reference Example 1

1669.2 g (4.194 mol) of lutetium oxide (Lu₂O₃), 12.12 g (0.07046 mol) of cerium oxide (CeO₂), 718.7 g (7.046 mol) of aluminum oxide (Al₂O₃), 144 g (0.8214 mol) of barium fluoride (BaF₂), and 12 g (0.06403 mol) of gallium oxide (Ga₂O₃) were weighed, placed in a polyethylene container together with alumina balls, and mixed in a ball mill for 4 hours to obtain a raw material mixture. The raw material mixture was provided into an alumina crucible, and the alumina crucible was disposed on a base plate covered with activated carbon. A large alumina crucible was placed over the alumina crucible in which the raw material mixture was provided. A first rare earth aluminate was obtained by heat treatment at 1625° C. for 10 hours using an electric furnace.

### Example 1

The first rare earth aluminate obtained in Reference Example 1 was provided into an alumina crucible and heat-treated at 1300° C. for 6 hours in an air atmosphere. The alumina crucible was then disposed on a base plate covered with activated carbon, and a larger alumina crucible was placed over the alumina crucible in which the first rare earth aluminate is provided, followed by heat treatment at a first heat treatment temperature of 1100° C. for 6 hours to obtain a first heat-treated product.

The obtained first heat-treated product was subjected to wet dispersion treatment and acid treatment as follows to obtain a rare earth aluminate phosphor. 100 g of the obtained first heat-treated product, 200 g of pure water, and 100 g of 2 mm diameter alumina beads were placed in a polyethylene container and dispersed at room temperature (25° C.) for 15 hours. Coarse particles were removed through a sieve. Acid washing was performed using hydrochloric acid, and fine particles were removed through sedimentation classification. A drying treatment was performed to obtain the rare earth aluminate phosphor of Example 1.

The resulting first rare earth aluminate was analyzed by high-frequency inductively coupled plasma (ICP) emission spectrometry and found to have the following composition:

Lu_{2.986}Ce_{0.014}Al_{4.952}Ga_{0.036}O₁₂

### Example 2

A rare earth aluminate phosphor of Example 2 was obtained in the same or similar manner as in Example 1, except that the heat treatment in the air atmosphere was not carried out.

### Example 3

A rare earth aluminate phosphor of Example 3 was obtained in the same or similar manner as in Example 2, except that the temperature of the first heat treatment was changed to 1000° C.

### Comparative Example 1

A rare earth aluminate phosphor of Comparative Example 1 was obtained in the same or similar manner as in Example 2, except that the first heat treatment temperature was changed to 1400° C.

### Comparative Example 2

A rare earth aluminate phosphor of Comparative Example 2 was obtained in the same or similar manner as in Example 2, except that the first heat treatment temperature was changed to 1300° C.

### Comparative Example 3

A rare earth aluminate phosphor of Comparative Example 3 was obtained in the same or similar manner as in Example 1, except that the first rare earth aluminate obtained in Reference Example 1 was heat-treated at 1100° C. for 6 hours in an air atmosphere to obtain a heat-treated product and that the obtained heat-treated product was subjected to a wet dispersion treatment and an acid treatment.

### Comparative Example 4

A rare earth aluminate phosphor of Comparative Example 4 was obtained in the same or similar manner as in Comparative Example 3, except that the heat treatment temperature was changed to 1300° C.

### Evaluation

The rare earth aluminate phosphor obtained above was evaluated as follows.

### Number Average Particle Size

The number average particle size was measured by the FSSS method using Fisher Sub-Sieve Sizer Model 95 (manufactured by Fisher Scientific, Inc.). The results are shown in Table 1.

### Light-Emitting Characteristics

The rare earth aluminate phosphor obtained above was irradiated with excitation light having a luminescence peak wavelength of 450 nm using a quantum efficiency measurement system (QE-2000, manufactured by Otsuka Electronics Co., Ltd.) to measure the emission spectrum. The chromaticity coordinates (x, y) in the chromaticity coordinate system of the CIE (Commission Internationale de I'Eclairage (International Commission on Illumination)) 1931 chromaticity diagram, the luminescence intensity at the luminescence peak wavelength, the luminescence peak wavelength (nm), and the full width at half maximum (FWHM) (nm) of the emission spectrum were obtained from the emission spectrum. The relative luminescence intensity (%) was calculated as a relative value of the luminescence intensity of each phosphor, with the luminescence intensity of the Comparative Example phosphor being 100%.

### Reflection Spectrum

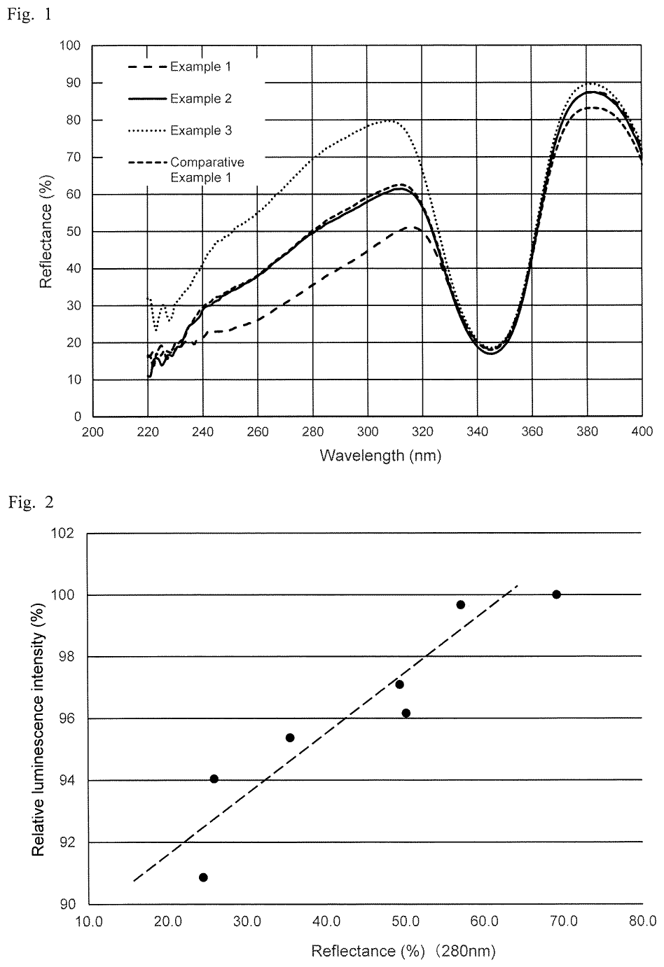

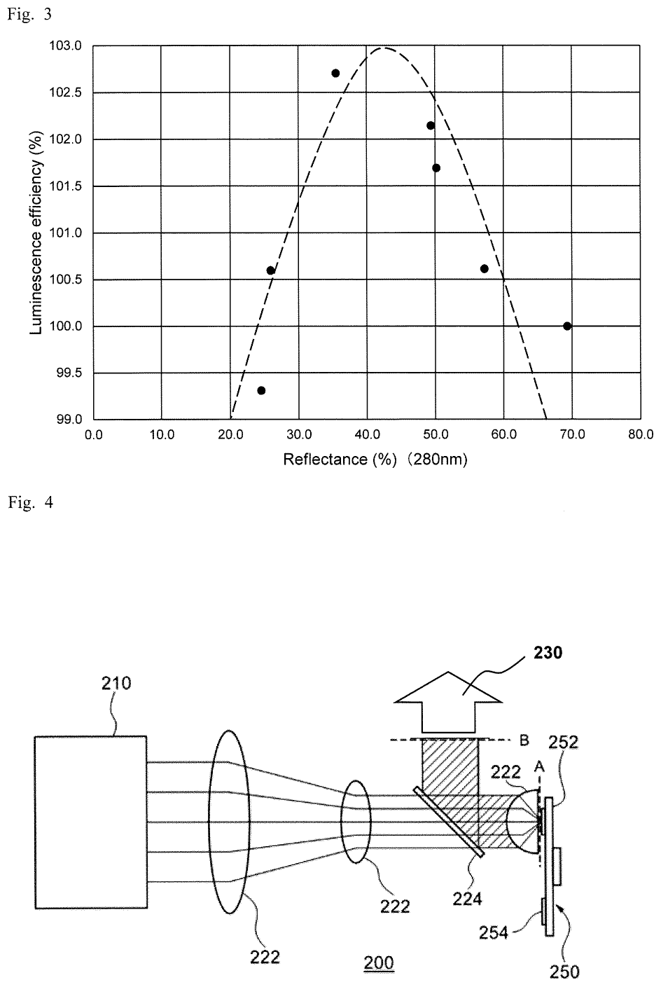

For the rare earth aluminate phosphors from Example 1 and Comparative Example 1, a spectrofluorophotometer (F-4500, manufactured by Hitachi High-Technologies Corporation) was used to irradiate each phosphor as a sample with light from a halogen lamp serving as an excitation light source at room temperature (25±5° C.), and the reflection spectrum of each phosphor was measured by scanning with the wavelengths of the spectroscopes on the excitation side and phosphor side matched. The reflection spectrum, with the reflectance of calcium hydrogen phosphate (CaHPO₄) taken as 100%, is shown in FIG. 1.

### Reflectance

For the rare earth aluminate phosphors obtained above, the spectrofluorophotometer (F-4500, manufactured by Hitachi High-Technologies Corporation) was used to irradiate each phosphor as a sample with light from a halogen lamp as an excitation light source at room temperature (25±5° C.), and the reflectance at each wavelength of 280 nm and 380 nm was measured by scanning with the wavelengths of the spectroscopes on the excitation side and phosphor side matched. As a reference, the reflectance of calcium hydrogen phosphate (CaHPO₄) was set to 100%.

FIG. 2 shows the relationship between the reflectance at a wavelength of 280 nm and the relative luminescence intensity obtained by measuring the light emitting characteristics.

### Fluorescence Lifetime

Each phosphor was irradiated with excitation light having a luminescence peak wavelength of 280 nm or 442 nm, and the change in fluorescence intensity of each phosphor over time from the point in time when the irradiation of the excitation light was cut off was measured using a compact fluorescence lifetime measurement device (Quantaurus-Tau, manufactured by Hamamatsu Photonics K. K.). The fluorescence lifetime was measured as the time until the fluorescence intensity became 1/e of the fluorescence intensity when the excitation light was cut off, with the fluorescence intensity upon the excitation light cutoff taken as 100%. The results are shown in Table 1. In Table 1, “−” indicates not applicable or not measured.

TABLE 1

| | Second | | Number | | | Light-emitting characteristics | | |
|---|---|---|---|---|---|---|---|---|
| | heat | First heat | average | | | Peak | Full width | Relative |
| | treatment | treatment | particle | Cromaticity | | luminescence | at half | luminescence |
| | temperature | temperature | size | coordinates | | wavelength | maximum | intensity |
| | (° C.) | (° C.) | (μm) | x | y | (nm) | (nm) | (%) |
| Example 1 | 1300 | 1100 | 30.0 | 0.332 | 0.583 | 519 | 98.9 | 95.4 |
| Example 2 | — | 1100 | 30.5 | 0.333 | 0.583 | 521 | 99.1 | 97.1 |
| Example 3 | — | 1000 | 31.5 | 0.332 | 0.583 | 517 | 99.5 | 96.2 |
| Comparative | — | 1400 | 31.5 | 0.333 | 0.583 | 521 | 98.9 | 100.0 |
| Example 1 | | | | | | | | |
| Comparative | — | 1300 | 31.5 | 0.333 | 0.583 | 521 | 99.0 | 99.7 |
| Example 2 | | | | | | | | |
| Comparative | 1100 | — | 30.0 | 0.331 | 0.584 | 518 | 98.8 | 92.1 |
| Example 3 | | | | | | | | |

| | Reflectance (%) | | | Fluorescence lifetime (ns) | | |
|---|---|---|---|---|---|---|
| | R³⁸⁰ | R²⁸⁰ | R²⁸⁰/ | T²⁸⁰ | T⁴⁴² | T²⁸⁰/ |
| | (380 nm) | (280 nm) | R³⁸⁰ | (280 nm) | (442 nm) | T⁴⁴² |
| Example 1 | 87.2 | 35.5 | 0.41 | 103.1 | 56.9 | 1.81 |
| Example 2 | 87.2 | 49.4 | 0.57 | 89.9 | 58.2 | 1.54 |
| Example 3 | 83.0 | 50.2 | 0.60 | — | — | — |
| Comparative | 89.5 | 69.3 | 0.77 | 87.1 | 57.5 | 1.51 |
| Example 1 | | | | | | |
| Comparative | 78.7 | 57.2 | 0.73 | 87.0 | 57.8 | 1.51 |
| Example 2 | | | | | | |
| Comparative | 80.3 | 25.9 | 0.32 | — | — | — |
| Example 3 | | | | | | |

### Fabrication of Wavelength Conversion Member

A substrate provided was a disk-shaped substrate formed of a metal containing aluminum, with a diameter of 65 mm and a thickness of 0.50 mm. The regular reflectance of the reflecting surface of the substrate for light of 450 nm was 98.2%.

500 parts by mass of each of the rare earth aluminate phosphors obtained above was added to 100 parts by mass of dimethyl silicone resin and mixed in a vacuum defoaming mixer to obtain a phosphor composition. The obtained phosphor composition was applied to the substrate by screen printing to form a phosphor composition layer. Subsequently, the substrate was heat-treated in an oven at 60° C. for 4 hours and then in an oven at 150° C. for 4 hours to form a wavelength conversion layer, thereby obtaining each wavelength conversion member.

### Relative Luminescence Efficiency

The relative luminescence efficiency (%) of each of the obtained wavelength conversion members was calculated as follows. The wavelength conversion member was irradiated with a laser beam from a laser diode having a wavelength of 450 nm at an intensity of 90 W through a dichroic mirror so that the diameter of the incident light on the wavelength conversion member was 1 mm. The radiant flux of the light exiting from the same surface as the surface on which the laser beam was incident was separated by a dichroic mirror, and the intensity of the exiting light was measured using an integrating sphere. The luminescence efficiency was calculated by dividing the intensity of the exiting light by the intensity of the incident light. The luminescence efficiency of the wavelength conversion member obtained using the rare earth aluminate phosphor of Comparative Example 1 was set to 100% as the reference, and the relative luminescence efficiency (%) of the luminescence efficiency of the wavelength conversion member obtained using the rare earth aluminate phosphor of each Example and Comparative Example was calculated. The results are shown in Table 2.

TABLE 2

| | Relative |
|---|---|
| | luminescence |
| | efficiency |
| | (%) |
| Example 1 | 102.6 |
| Example 2 | 102.1 |
| Example 3 | 101.6 |
| Comparative | 100.0 |
| Example 1 | |
| Comparative | 100.6 |
| Example 2 | |
| Comparative | 100.6 |
| Example 3 | |

It is to be understood that although the present disclosure has been described with regard to preferred embodiments thereof, various other embodiments and variants may occur to those skilled in the art, which are within the scope and spirit of the invention, and such other embodiments and variants are intended to be covered by the following claims.

Although the present disclosure has been described with reference to several exemplary embodiments, it is to be understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular examples, means, and embodiments, the disclosure may be not intended to be limited to the particulars disclosed; rather the disclosure extends to all functionally equivalent structures, methods, and uses such as are within the scope of the appended claims.

One or more examples or embodiments of the disclosure may be referred to herein, individually and/or collectively, by the term “disclosure” merely for convenience and without intending to voluntarily limit the scope of this application to any particular disclosure or inventive concept. Moreover, although specific examples and embodiments have been illustrated and described herein, it should be appreciated that any subsequent arrangement designed to achieve the same or similar purpose may be substituted for the specific examples or embodiments shown. This disclosure may be intended to cover any and all subsequent adaptations or variations of various examples and embodiments. Combinations of the above examples and embodiments, and other examples and embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure may be not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter shall be considered illustrative, and not restrictive, and the appended claims are intended to cover all such modifications, enhancements, and other embodiments which fall within the true spirit and scope of the present disclosure. Thus, to the maximum extent allowed bylaw, the scope of the present disclosure may be determined by the broadest permissible interpretation of the following claims and their equivalents, and shall not be restricted or limited by the foregoing detailed description.

All publications, patent applications, and technical standards mentioned in this specification are herein incorporated by reference to the same extent as if each individual publication, patent application, or technical standard was specifically and individually indicated to be incorporated by reference.

What is claimed is:

1. A rare earth aluminate phosphor comprising:
a first element M¹ including at least one selected from the group consisting of yttrium (Y), lanthanum (La), lutetium (Lu), gadolinium (Gd), and terbium (Tb);
cerium (Ce);
aluminum (Al);
oxygen atoms (O), and
optionally a second element M² including at least one selected from the group consisting of gallium (Ga) and scandium (Sc),
wherein the rare earth aluminate phosphor has a composition in which, when a number of moles of oxygen atoms is 12, a total number of moles of the first element M¹ and cerium is 2.9 or more and 3.1 or less and a total number of moles of aluminum and the second element M² is 4.5 or more and 5.5 or less, and
wherein the rare earth aluminate phosphor has a reflection spectrum in which a ratio of reflectance at a wavelength of 280 nm to reflectance at a wavelength of 380 nm is 0.33 or more and 0.76 or less.

2. The rare earth aluminate phosphor according to claim 1, wherein a ratio of fluorescence lifetime at an excitation wavelength of 280 nm to fluorescence lifetime at an excitation wavelength of 442 nm is greater than 1.51.

3. The rare earth aluminate phosphor according to claim 1, wherein
the rare earth aluminate phosphor has a composition in which a ratio of a number of moles of cerium to the total number of moles of the first element M¹ and cerium is 0.002 or more and 0.018 or less, and a ratio of a number of moles of the second element M² to the total number of moles of aluminum and the second element M² is 0.6 or less.

4. The rare earth aluminate phosphor according to claim 1, having a composition represented by formula (1) below:
(M¹₍₁₋ₚ₎Ceₚ)_{q}(Al₍₁₋ᵣ₎M²ᵣ)ₛO₁₂ (1)
wherein M¹ includes at least one selected from the group consisting of Y, La, Lu, Gd, and Tb; M² includes at least one selected from the group consisting of Ga and Sc; and p, q, r, and s satisfy 0.002≤p≤0.018, 2.9≤q≤3.1, r≤0.6, and 4.5≤s≤5.5.

5. The rare earth aluminate phosphor according to claim 1, wherein
a number average particle size of the rare earth aluminate phosphor is 10 μm or more and 60 μm or less.

6. The rare earth aluminate phosphor according to claim 1, wherein
a luminescent color of the rare earth aluminate phosphor at an excitation wavelength of 450 nm has a value of x in chromaticity coordinates of CIE 1931 colorimetric system that is 0.29 or more and 0.35 or less.

7. A wavelength conversion member comprising:
a substrate; and
a wavelength conversion layer disposed on the substrate, the wavelength conversion layer comprising a binder and the rare earth aluminate phosphor according to claim 1.

8. The wavelength conversion member according to claim 7, wherein a content of the rare earth aluminate phosphor in the wavelength conversion layer is 50 parts by mass or more and 700 parts by mass or less per 100 parts by mass of the binder.

9. The wavelength conversion member according to claim 7, wherein
an average thickness of the wavelength conversion layer is 50 μm or more and 200 μm or less.

10. Alight emitting device comprising:
the wavelength conversion member according to claim 7; and
a light source that irradiates the wavelength conversion member with light.

11. The light emitting device according to claim 10, wherein
an optical power density of an output of the light source irradiating the wavelength conversion member is 50 mW/mm² or more and 1000 mW/mm² or less.

12. A projector comprising:
the light emitting device according to claim 10;
an image display system; and
a projection optical system.

13. A method for producing a rare earth aluminate phosphor, comprising:
providing a first rare earth aluminate comprising:
a first element M¹ including at least one selected from a group consisting of yttrium (Y), lanthanum (La), lutetium (Lu), gadolinium (Gd), and terbium (Tb);
cerium (Ce);
aluminum (Al);
oxygen atoms (O), and
optionally a second element M² including at least one selected from the group consisting of gallium (Ga) and scandium (Sc),
wherein the rare earth aluminate phosphor has a composition in which, when a number of moles of oxygen atoms is 12, a total number of moles of the first element M¹ and cerium is 2.9 or more and 3.1 or less, and a total number of moles of aluminum and the second element M² is 4.5 or more and 5.5 or less; and
subjecting the first rare earth aluminate to a first heat treatment at a temperature of 900° C. or higher and lower than 1300° C. in a reducing atmosphere to obtain a first heat-treated product.

14. The method according to claim 13, wherein
the first heat treatment is carried out in the presence of a carbon source.

15. The method according to claim 13, further comprising: subjecting the first rare earth aluminate to a second heat treatment in the presence of oxygen prior to the first heat treatment.

16. The method according to claim 15, wherein
the second heat treatment is carried out at a temperature higher than the temperature of the first heat treatment.

17. The method according to claim 13, further comprising:
wet-dispersing the first heat-treated product.

18. The method according to claim 13, further comprising:
bringing the first heat-treated product into contact with an acidic liquid medium.
